(19) United States
(12) Patent Application Publication
(10) Pub. No.: US 2002/0133560 A1
(43) Pub. Date: Sep. 19, 2002

(54) Information providing apparatus, method for providing information, and program thereof

(76) Inventor: Tetsuo Hara, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/863,079

(22) Filed: May 23, 2001

(30) Foreign Application Priority Data
Mar. 15, 2001 (JP) PCT/JP01/02075

(51) Int. Cl. G06F 15/167

(52) U.S. Cl. 709/213; 709/217

(57) ABSTRACT

An information providing apparatus for providing information to the user based on an action plan, comprising: an acquiring unit for acquiring the action plan, which includes a time and date schedule of the user; a time and date detecting unit for detecting present time and date; a provision-information selecting unit connected to the acquiring unit and the time and date detecting unit, the provision-information selecting unit selecting provision-information provided to the user according to the time difference between the present time and date, which is detected by the time and date detecting unit, and the time and date schedule of the action plan acquired from the acquiring unit; and a providing unit connected to the provision-information selecting unit, the providing unit providing the user with the provision-information selected by the provision-information selecting unit.

This patent application claims priority from a Japanese patent application No. PCT/JP01/02075 filed on Mar. 15th, 2001, the contents of which are incorporated herein by reference.

### BACKGROUND OF THE INVENTION

1. Field of the Invention

The present invention relates to an information providing apparatus, a method for providing information, and a program thereof. In particular, the present invention relates to an information providing apparatus, a method for providing information, and a program thereof for providing suitable information to the user at an appropriate time.

2. Description of the Related Art

Recently, because of the development of an information providing apparatus for providing information through the Internet, a user can easily obtain information that he or she wants. However, with the recent development of the Internet, a flood of information has become oversupplied to the user. Therefore, it is required to select and provide information to the user in a form that the user desires.

### SUMMARY OF THE INVENTION

Therefore, it is an object of the present invention to provide an information providing apparatus, a method for providing information, and a program thereof, which is capable of overcoming the above drawbacks accompanying the conventional art. The above and other objects can be achieved by combinations described in the independent claims. The dependent claims define further advantageous and exemplary combinations of the present invention.

According to the first aspect of the present invention, an information providing apparatus for providing information to the user based on an action plan, comprises: an acquiring unit for acquiring the action plan, which includes a time and date schedule of the user; a time and date detecting unit for detecting the present time and date; a provision-information selecting unit connected to the acquiring unit and the time and date detecting unit, the provision-information selecting unit selecting provision-information provided to the user according to the time difference between the present time and date, which is detected by the time and date detecting unit, and the time and date schedule of the action plan acquired from the acquiring unit; and a providing unit connected to the provision-information selecting unit, the providing unit providing the user with the provision-information selected by the provision-information selecting unit.

The action plan is a travel plan that includes information of a travel destination of the user as an action content of the user. The apparatus may further comprise: a position detecting unit for detecting a position of a portable terminal carried with the user; and the provision-information selecting unit selects the provision-information according to the position of the portable terminal detected by the position detecting unit.

The apparatus may further comprise: a provision-information database which stores said provision-information with corresponding said time difference, wherein: the provision-information selecting unit may select provision-information using said provision-information database.

The provision-information selecting unit may select information, which is related to preparation for travel indicated in the travel plan, as the provision-information when the present time and date is within a first period, which is a period from a predetermined time and date before the time and date schedule to the time and date schedule.

The action plan may include the time and date schedule of travel with corresponding the travel destination at the time and date schedule; and the provision-information selecting unit may select information, which is related to the travel destination corresponding to the time and date schedule indicated in the action plan, as the provision-information when the present time and date is within a second period, which is a period from said time and date schedule to a predetermined time and date after said time and date schedule.

The apparatus may further comprise: a position detecting unit for detecting a position of a portable terminal carried with the user when the time and date detecting unit detects the present time and date; a comparing unit connected to the acquiring unit, the time and date detecting unit, and the position detecting unit, the comparing unit comparing the travel destination at the time and date schedule corresponding to the present time and date with the position of the portable terminal or comparing the time and date schedule at the travel destination corresponding to the position of the portable terminal with the present time and date; and a travel plan modifying unit for modifying the action plan when the travel destination at the time and date schedule corresponding to the present time and date does not match the position of the portable terminal or when the time and date schedule at the travel destination corresponding to the position of the portable terminal does not match the present time and date.

The provision-information selecting unit may select the provision-information according to a purpose of an action of the user in the action plan. The provision-information selecting unit may select the provision-information according to a past action history of the user.

The apparatus may further comprise a user history database for storing the action plan acquired from the acquiring unit as action history information of the user with corresponding user identification information, which is used for identifying the user, wherein: the provision-information selecting unit may select the provision-information using the action history information stored in the user history database.

The apparatus may further comprise: a user history database for storing the position of the portable terminal detected by the position detecting unit as action history information with corresponding user identification information, which is used for identifying the user who carries the portable terminal, wherein: the provision-information selecting unit may select the provision-information using the action history information stored in the user history database.

The provision-information selecting unit may differentiate a degree of minuteness of the provision-information according to a distance from an edge of a terminal designating area, which is previously determined for each of the portable terminals, to the position of the portable terminal. The provision-information selecting unit may select a type of the provision-information according to a distance from an edge of a terminal designating area, which is previously determined for each of the portable terminals, to the position of the portable terminal.

The apparatus may further comprise: a portable terminal area table which contains portable terminal identification information for identifying the portable terminal and the terminal designating area corresponding to the portable terminal identification information, wherein: the provision-information selecting unit may recognize the terminal designating area designated to the portable terminal using the portable terminal identification information.

The apparatus may further comprise: an area designating unit for designating the terminal designating area to the portable terminal based on a past action history of the user. The provision-information selecting unit selects the provision-information according to a number of times visiting the travel destination by the user. The provision-information selecting unit may select the provision-information according to personal information of the user.

According to the second aspect of the present invention, an information providing apparatus for providing information to the user based on an action plan for travel of the user, comprises: an acquiring unit for acquiring the action plan, which includes a time and date schedule for the travel and a travel destination corresponding to the time and date schedule; a time and date detecting unit for detecting a present time and date; a position-detecting unit for detecting a position of a portable terminal carried with the user; a comparing unit connected to the acquiring unit, the time and date detecting unit, and the position detecting unit, the comparing unit outputting a difference-signal representing at least one of a time difference and a position difference according to the signal output from said acquiring unit, said time and date detecting unit, and said position detecting unit; a provision-information selecting unit connected to said comparing unit, said provision-information selecting unit selecting provision-information provided to the user based on the difference-signal output from the comparing unit; and a providing unit connected to the provision-information selecting unit for providing the user with the provision-information selected by the provision-information selecting unit.

The comparing unit may output the difference-signal representing the position difference by comparing the travel destination at the time and date schedule corresponding to the present time and date with the position of the portable terminal. The comparing unit may output the difference-signal representing the time difference by comparing the time and date schedule at the travel destination corresponding to the position of the portable terminal with the present time and date.

The comparing unit may further output an agreement signal representing an inverse of a degree of the time difference or the position difference obtained by the comparison; and the provision-information selecting unit may select the provision-information according to the agreement signal output from the comparing unit.

The apparatus may further comprise: a travel plan modifying unit for modifying the action plan when the travel destination at the time and date schedule corresponding to the present time and date does not match the position of the portable terminal or when the time and date schedule at the travel destination corresponding to the position of the portable terminal does not match the present time and date, wherein: the position-detecting unit may detect a position of the portable terminal when the time and date detecting unit detects the present time and date.

The provision-information selecting unit may select the provision-information according to a purpose of the travel. The provision-information selecting unit may select the provision-information according to action history of the user.

The apparatus may further comprise: a user history database for storing the action plan acquired from the acquiring unit as action history information of the user with corresponding user identification information, which is used for identifying the user, wherein: the provision-information selecting unit may select the provision-information using the action history information stored in the user history database.

The apparatus may further comprise: a user history database for storing the position of the portable terminal detected by the position detecting unit as action history information with corresponding user identification information, which is used for identifying the user who carries the portable terminal, wherein: the provision-information selecting unit may select the provision-information using the action history information stored in the user history database.

The provision-information selecting unit may differentiate a degree of minuteness of the provision-information according to a distance from an edge of a terminal designating area, which is previously determined for each of the portable terminals, to the position of the portable terminal. The provision-information selecting unit may select a type of the provision-information according to a distance from an edge of a terminal designating area, which is previously determined for each of the portable terminals, to the position of the portable terminal.

The apparatus may further comprise: a portable terminal area table which contains portable terminal identification information for identifying the portable terminal and the terminal designating area corresponding to the portable terminal identification information, wherein: the provision-information selecting unit recognizes the terminal designating area designated to the portable terminal using the portable terminal identification information.

The apparatus may further comprise: an area designating unit for designating the terminal designating area to the portable terminal based on action history of the user. The provision-information selecting unit may select the provision-information according to a number of times visiting the travel destination by the user. The provision-information selecting unit may select the provision-information according to personal information of the user.

According to the third aspect of the present invention, an information providing apparatus for providing information to the user, comprises: a position-detecting unit for detecting a position of a portable terminal carried with the user; a provision-information selecting unit connected to the position detecting unit, the provision-information selecting unit selecting first provision-information corresponding to the position of the portable terminal detected by the position detecting unit when the position detecting unit detects that the portable terminal positions inside a predetermined area designated to the portable terminal, and the provision-information selecting unit further selecting second provision-information corresponding to the position of the portable terminal detected by the position detecting unit when the position detecting unit detects that the portable terminal positions outside a predetermined area designated to the portable terminal; and a providing unit connected to the provision-information selecting unit, the providing unit providing the user with one of the first provision-information and the second provision-information selected by the provision-information selecting unit.

The provision-information selecting unit may select one of the first provision-information and the second provision-information according to moving distance information which indicates a distance from a position of the portable terminal and an edge of the predetermined area designated to the portable terminal.

The apparatus may further comprise: a provision-information database for storing the first provision-information and the second provision-information with corresponding the moving distance information; and the provision-information selecting unit may select one of the first provision-information and the second provision-information using the provision-information database.

The provision-information selecting unit may select one of the first provision-information and the second provision-information according to the predetermined area determined based on action history of the user.

The apparatus may further comprise: a user history database for storing the position of the portable terminal detected by the position detecting unit as action history information with corresponding user identification information, which is used for identifying the user who carries the portable terminal, wherein: the provision-information selecting unit selects one of the first provision-information and the second provision-information using the action history information stored in the user history database.

The apparatus may further comprise: a user history database for storing the action plan acquired from the acquiring unit as action history information of the user with corresponding user identification information, which is used for identifying the user, wherein: the provision-information selecting unit may select one of the first provision-information and the second provision-information based on the predetermined area determined by the action history information stored in the user history database.

The provision-information selecting unit may differentiate a degree of minuteness of one of the first provision-information and the second provision-information according to a distance from an edge of the predetermined area to the position of the portable terminal. The provision-information selecting unit may select a type of one of the first provision-information and the second provision-information according to a distance from an edge of the predetermined area to the position of the portable terminal.

The apparatus may further comprise: a portable terminal area table which includes portable terminal identification information for identifying the portable terminal and the predetermined area corresponding to the portable terminal identification information, wherein: the provision-information selecting unit may recognize the predetermined area using the portable terminal area table. The apparatus may further comprise: an area designating unit for designating the predetermined area to the portable terminal based on action history of the user.

The provision-information selecting unit may select one of the first provision-information and the second provision-information according to the predetermined area determined on the number of times the user visits the predetermined area. The provision-information selecting unit may select one of the first provision-information and the second provision-information according to the predetermined area determined on personal information of the user.

According to the fourth aspect of the present invention, an information providing apparatus for providing information to the user, comprises: a position-detecting unit for detecting a position of a portable terminal carried with the user; a provision-information selecting unit connected to the position detecting unit, the provision-information selecting unit selecting provision-information to be provided to the user, which corresponds to the position of the portable terminal, according to a distance of the position of the portable terminal from an edge of a predetermined area designated to the portable terminal; and a providing unit connected to the provision-information selecting unit for providing the user with the provision-information selected by the provision-information selecting unit.

According to the fifth aspect of the present invention, a method for providing information to the user based on an action plan, comprises: acquiring the action plan, which includes a time and date schedule of the user; detecting present time and date; selecting provision-information according to the time difference between the present time and date and the time and date schedule of the action plan; and providing the user with the selected provision-information.

According to the sixth aspect of the present invention, a method for providing information to the user based on an action plan for travel of the user, comprises: acquiring the action plan, which includes a time and date schedule for the travel and a travel destination corresponding to the time and date schedule; detecting a present time and date; detecting a position of a portable terminal carried with the user; outputting a difference-signal representing at least one of a time difference and a position difference according to the time and date schedule, the travel destination, the present time and date, and the position of the portable terminal; selecting provision-information based on the difference-signal; and providing the user with the selected provision-information.

According to the seventh aspect of the present invention, a method for providing information to the user, comprising: detecting a position of a portable terminal carried with the user; selecting first provision-information corresponding to the position of the portable terminal when the position of the portable terminal is detected to be inside a predetermined area designated to the portable terminal; selecting second provision-information corresponding to the position of the portable terminal when the position of the portable terminal is detected to be outside a predetermined area designated to the portable terminal; and providing the user with one of the first provision-information and the second provision-information selected by the selecting.

According to the eighth aspect of the present invention, a computer program for providing information to the user based on an action plan, comprising: an acquiring module for acquiring the action plan, which includes a time and date schedule of the user; a time and date detecting module for detecting present time and date; a provision-information selecting module for selecting provision-information provided to the user according to the time difference between the present time and date, which is detected by the time and date detecting module, and the time and date schedule of the action plan acquired from the acquiring module; and a providing module for providing the user with the provision-information selected by the provision-information selecting module.

According to the ninth aspect of the present invention, a computer program for providing information to the user based on an action plan for travel of the user, comprises: an acquiring module for acquiring the action plan, which includes a time and date schedule for the travel and a travel destination corresponding to the time and date schedule; a time and date detecting module for detecting a present time and date; a position-detecting module for detecting a position of a portable terminal carried with the user; a comparing module for outputting a difference-signal representing at least one of a time difference and a position difference according to the signal output from the acquiring module, the time and date detecting module, and the position detecting module; a provision-information selecting module for selecting provision-information provided to the user based on the difference-signal output from the comparing module; and a providing module for providing the user with the provision-information selected by the provision-information selecting module.

According to the tenth aspect of the present invention, a computer program for providing information to the user, comprises: a position-detecting module for detecting a position of a portable terminal carried with the user; a provision-information selecting module for selecting first provision-information corresponding to the position of the portable terminal detected by the position detecting module when the position detecting module detects that the portable terminal positions inside a predetermined region designated to the portable terminal, and selecting second provision-information corresponding to the position of the portable terminal detected by the position detecting module when the position detecting module detects that the portable terminal position is outside a predetermined region designated to the portable terminal; a providing module for providing the user with one of the first provision-information and the second provision-information selected by the provision-information selecting module.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an information providing system of the present embodiment.

FIG. 2 is a block diagram that shows a configuration of the information providing apparatus 100.

FIG. 3 shows a data configuration of the information table.

FIG. 4 shows a data configuration of the provision-information that is actually stored in the provision-information database 120.

FIG. 5 shows a data configuration of the user database 122.

FIG. 6 shows a data configuration of the user history database 124.

FIG. 7 shows an example of a data configuration of the travel plan file.

FIG. 8 is a flow chart that shows an operation of the information providing apparatus 100 of the present embodiment.

FIG. 9 is a flow chart that shows a detailed operation of the information providing apparatus 100.

FIG. 10 shows a hardware configuration of the information providing apparatus 100.

FIG. 11 is a block diagram that shows a configuration of the information providing apparatus 100 of the second embodiment.

FIG. 12 shows a data configuration of the provision-information database 120.

FIG. 13 shows a configuration of the data configuration of the user history database 124.

FIG. 14 shows a flow chart for describing the operation of the information providing apparatus 100 of the second embodiment.

### DETAILED DESCRIPTION OF THE INVENTION

The invention will now be described based on the preferred embodiments, which do not intend to limit the scope of the present invention, but exemplify the invention. All of the features and the combinations thereof described in the embodiments are not necessarily essential to the invention.

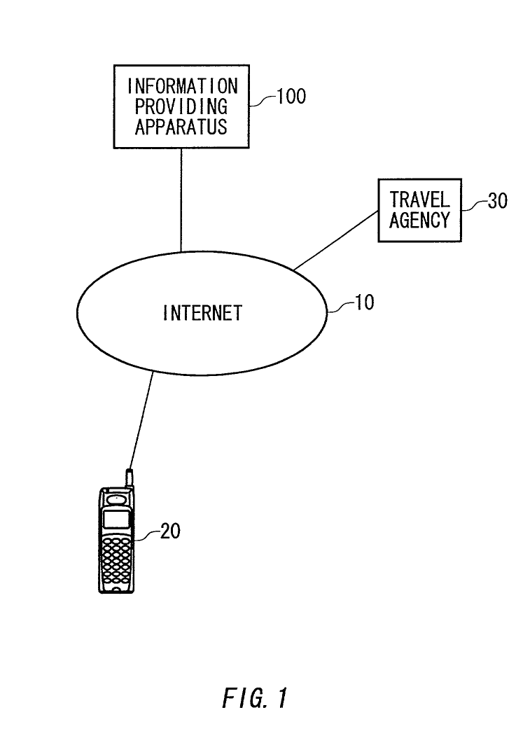

FIG. 1 shows an information providing system of the present embodiment. The information providing system comprises an information providing apparatus 100, a travel agent server 30, and a portable terminal 20. The portable terminal 20 may be a portable telephone that can be connected to the Internet 10.

The travel agent server 30 receives an application for a tour from the user. The travel agent server 30 sends the travel plan of the user to the information providing apparatus 100 via the Internet 10. The travel plan applied for by the user includes information regarding the contents of a tour. The travel agent server 30 may communicate with the information providing apparatus 100 via a leased circuit. The information providing apparatus 100 stores information of the user and the travel plan received from the travel agent server 30.

The information providing apparatus 100 provides to the user the information necessary for the user at the time when the user needs the information based on the travel schedule indicated in the travel plan. Therefore, the information providing apparatus 100 can provide the user with the information necessary for the user at a time when the user needs the information while the user goes traveling.

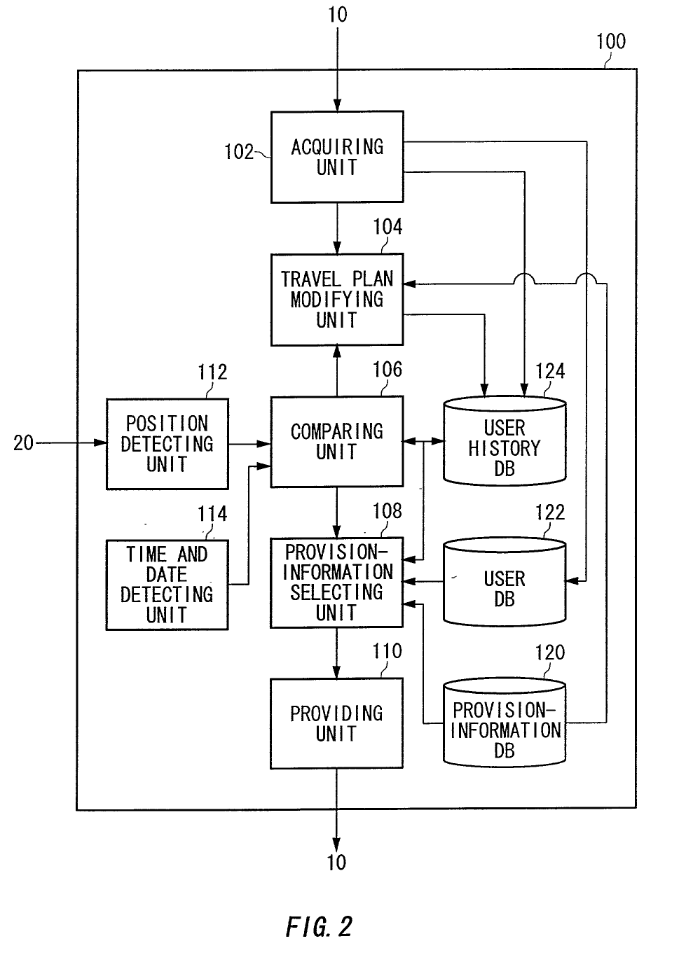

FIG. 2 is a block diagram that shows a configuration of the information providing apparatus 100. The program stored mainly in the CPU, ROM, and RAM in the information providing apparatus 100 works together to realize a series of operations performed by the information providing apparatus 100. The information providing apparatus 100 may be configured by the other elements described in the following embodiments. Therefore, there is a large degree of freedom for designing the configuration of the information providing apparatus 100.

The information providing apparatus 100 comprises an acquiring unit 102, a travel plan modifying unit 104, a comparing unit 106, a provision-information selecting unit 108, a providing unit 110, a position detecting unit 112, a time and date detecting unit 114, a provision-information database 120, a user database 122, and a user history database 124.

The acquiring unit 102 acquires a travel plan via the Internet 10. Here, the travel plan is information including contents of actions and a time and date schedule corresponding to the contents of the actions. The position-detecting unit 112 detects a position of a portable terminal 20 carried with the user. The position-detecting unit 112 then sends the position information, which indicates the position of the portable terminal 20 detected by the position-detecting unit 112, to the comparing unit 106. The time and date detecting unit 114 detects a present time and date and sends the detected present time and date to the comparing unit 106.

The provision-information database 120 stores provision-information to be provided to the user such that the provision-information corresponds with the time and date information. The time and date information indicates the time difference between the present time and date and the time and date schedule of the travel departure indicated in the travel plan.

The user database 122 stores personal information relating to the user, such as a users address, so that the personal information corresponds with the user identification information for identifying the user. The user history database 124 receives a travel plan from the acquiring unit 102 and stores the travel plan for each user such that each travel plan corresponds with the user identification information. The user history database 124 may acquire the travel plan from the portable terminal 20 or the travel agent server 30 through the Internet 10 and the acquiring unit 102.

The comparing unit 106 compares the position information received from the position-detecting unit 112 with the contents of the action stored in the user history database 124. The comparing unit 106 also compares the present time and date received from the time and date detecting unit 114 with the time and date schedule of the action stored in the user history database 124. Then, the comparing unit 106 outputs the comparison result to the provision-information selecting unit 108.

The provision-information selecting unit 108 receives the comparison result from the comparing unit 106. The provision-information selecting unit 108 selects the provision-information to be provided to the user using the provision-information database 120, the user database 122, and the user history database 124. The providing unit 110 sends the provision-information selected by the provision-information selecting unit 108 to the portable terminal 20 of the user via the Internet 10.

In other words, the comparing unit 106 outputs a difference-signal representing at least one of a time difference and a position difference according to the signal output from the acquiring unit 106, the time and date detecting unit 114, and the position detecting unit 112. The provision-information selecting unit 108 selects provision-information provided to the user based on the difference-signal output from the comparing unit 106.

The travel plan modifying unit 104 modifies the travel plan stored in the user history database 124 based on the information acquired through the acquiring unit 102 and the comparison result received from the comparing unit 106

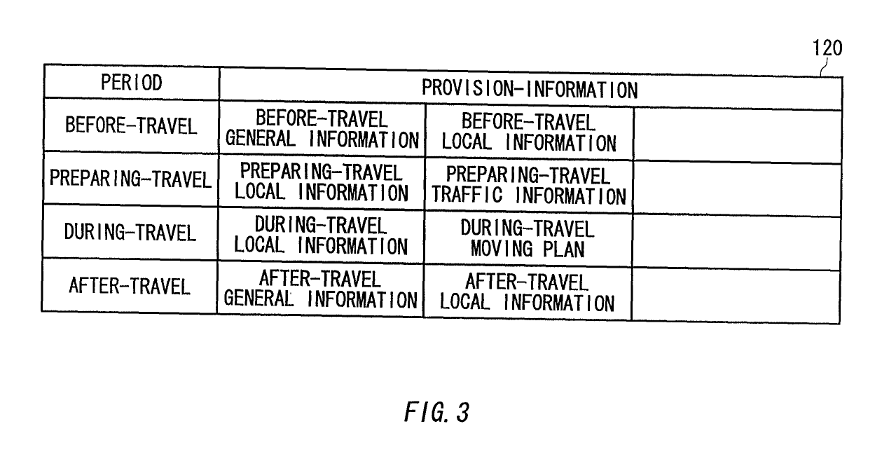

FIG. 3 shows a data configuration of the information table. The information table of FIG. 3A shows a relationship between each piece of information stored in the provision-information database 120. The provision-information database 120 has a period field and a provision-information field. The period field stores time and date information that indicates a time difference between the present time and date and a travel-departure time and date schedule. In the present embodiment, the period field stores information for four periods such as a before-travel period, a preparing-travel period, a during-travel period, and an after-travel period.

The before-travel period is an example of a first period, and the preparing-travel period is an example of a second period in the claims.

Here, the before-travel period may be a period from three months before the travel-departure time and date schedule to one month before the travel-departure time and date schedule. The preparing-travel period may be a period from one-month before the travel-departure time and date schedule to the travel-departure time and date schedule. The during-travel period may be a period from the travel-departure time and date schedule to the time and date schedule at the end of traveling. The after-travel period may be a period after the time and date of the end of traveling.

The provision-information field stores information that designates each provision-information to be provided to the user. The provision-information field corresponding to the before-travel period stores information that designates general information. The general information includes the before-travel general information and the before-travel local information. Here, the before-travel general information may be general information related to the travel in general. The before-travel local information may be the information related to the area where the user plans to travel.

In this way, the provision-information database 120 stores the general information related to the travel in general and the general information related to the area where the user plans to travel. Therefore, the provision-information selecting unit 108 can select the general information as the provision-information to be provided to the user during the before-travel period.

The provision-information field corresponding to the preparing-travel period stores information that designates the information, which is necessary during preparing to travel. The information, which is necessary during preparing to travel, includes preparing-travel local information and preparing-travel traffic information.

Here, the preparing-travel local information may be information such as the event held at the travel destination during the schedule of travel. The preparing-travel traffic information may be the information that indicates the service condition or the reservation condition of the train or the airplane. In this way, the provision-information database 120 stores the information related to preparing for travel that corresponds to the preparing-travel period. Therefore, the provision-information selecting unit 108 can select the information necessary for preparing to travel during the preparing-travel period.

The provision-information field corresponding to the during-travel period stores the information that indicates the information to be provided to the user during the during-travel period. The information necessary during the travel period includes during-travel local information and a during-travel moving plan. Here, the during-travel local information may be information such as the event held at the travel destination, for example.

In this way, the provision-information database 120 stores the information relating to the travel destination and the travel plan corresponding to the during-travel period. Therefore, the provision-information selecting unit 108 can select the information relating to the travel destination and the travel plan of the user while the user travels. The user thus can refer to his or her travel plan while traveling.

The provision-information corresponding to the after travel period stores the information that designates the information relating to the travel in general, and a questionnaire related to the travel.

In this way, the provision-information database 120 stores each kind of provision-information that corresponds to each period classified based on the time and date information indicated on the travel plan. Therefore, the provision-information selecting unit 108 can select the information necessary for the user at the present moment and provide the selected information to the user at the appropriate time using the provision-information database 120.

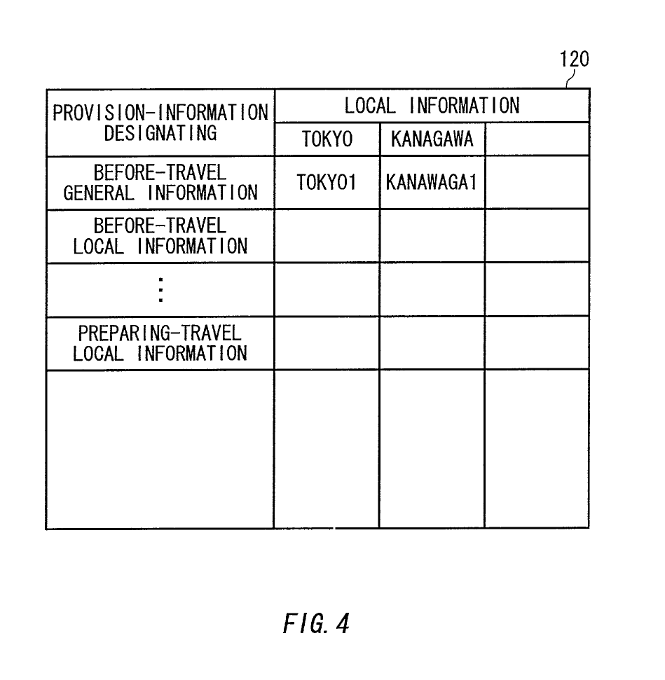

FIG. 4 shows a data configuration of the provision-information that is actually stored in the provision-information database 120. The provision-information database 120 has a provision-information designating field and a local information field. Furthermore, the local information field has fields for each area such as a Tokyo field, a Kanagawa field, and so on. The provision-information designating field stores information that designates each provision-information such as before-travel general information. Each of the Tokyo field and the Kanagawa field stores the provision-information relating to the Tokyo metropolitan area and Kanagawa prefecture, respectively. Therefore, the provision-information selecting unit 108 can further select the provision-information by limiting the scope of the information of the provision-information, which is selected based on the present time and date, based on the area.

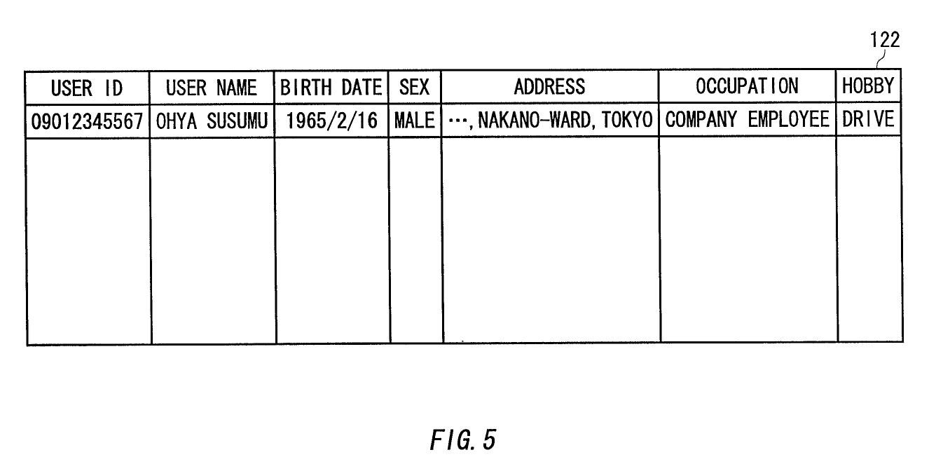

FIG. 5 shows a data configuration of the user database 122. The user database 122 has a user ID field, a user name field, a birth date field, a sex field, an address field, an occupation field, and a hobby field. The user ID field stores user identification information that identifies the user. The user name field stores the user's name. The birth date field stores the birth date of the user. The sex field stores the sex of the user. The address field stores the address of the user. The occupation field stores the occupation of the user. The hobby field stores a preferred hobby of the user.

The user identification information in the present embodiment is a telephone number of the portable telephone carried with the user. As another example, the user identification information may be portable terminal identification information that identifies the portable telephone carried with the user. The user database 122 may store the information relating to the individual tastes of the user. In this way, the user database 122 stores the information peculiar to the user. Because the user database 122 stores the personal information of each user, the provision-information selecting unit 108 can select the provision-information suitable for the personal information of each user using the user database 122.

In the present embodiment, the user information has been previously stored in the user database 122 by inputting the user information from the portable terminal 120 or the travel agent server 30. Alternatively, the user information may be obtained via the acquiring unit 102 with the travel plan of the user and stored in the user database 122.

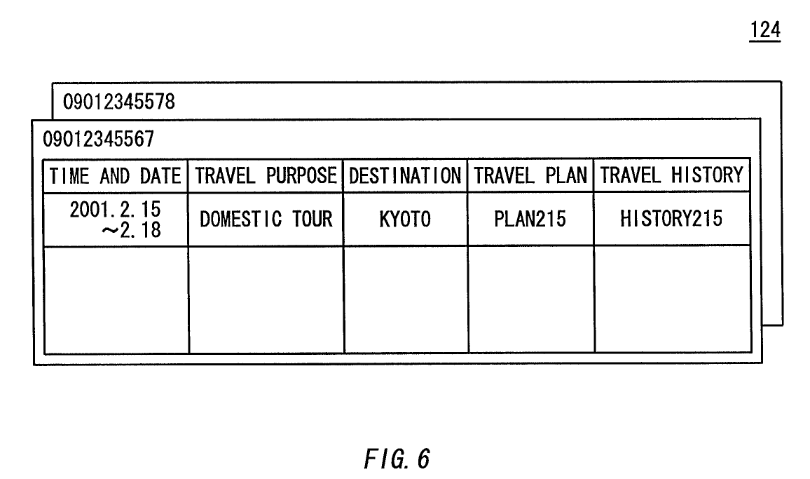

FIG. 6 shows a data configuration of the user history database 124. The user history database 124 has tables for each user identified by the user ID shown in FIG. 5. The tables for each user have a time and date field, a travel purpose field, a destination field, a travel plan field, and a travel history field.

The date and time field stores the time and date schedule of the travel plan. The time and date schedule may be a travel-departure time and date schedule, a travel-finishing time and date schedule, and so on, for example. The travel purpose field stores the purpose of the travel of the user. Included as examples of the travel purpose are sightseeing, visiting an historic spot, or a business trip. The travel destination field stores the information that indicates the travel destination. The information for indicating the travel destination may include information that indicates the prefectures such as Kyoto, and may be a location such as Kiyomizu-temple. The range of the location is not limited to the present embodiment.

The travel plan field stores the file name that designates the file, which indicates the action plan of the user. In FIG. 6, the file name of the travel plan 215 is stored in the travel plan field. The action plan field accumulates the travel plan each time a travel plan is acquired through the acquiring unit 102.

The travel history field stores a travel history file that indicates the travel history of the user and where the user has actually traveled in the past. The travel history field accumulates the information, which is provided to the user from the providing unit 110. The travel history field further accumulates the information provided to the user from the providing unit 110 and further accumulates the position detected by the position detecting unit 112 in the travel history field. For example, one travel history file may be made for one travel plan.

In this way, the user history database 124 stores the user's travel plan and the travel history for each user. Therefore, the provision-information selecting unit 108 can select the provision-information according to the user's travel purpose by using the user history database 124. Furthermore, the provision-information selecting unit 108 can select the provision-information according to the user's past travel history by referring to the user's travel history file.

Specifically, the provision-information selecting unit 108 may select further detailed information relating to the travel destination area indicated in the travel plan when the user has traveled to the travel destination indicated in the travel plan several times before. Moreover, the provision-information selecting unit 108 may select the information other than the place indicated in the travel history file. That is, the provision-information selecting unit 108 can select the provision-information provided to the user according to the number of times the user has traveled to the destination indicated in the travel plan.

As another example, each of the tables stored in the user history database 124 may not have a travel purpose field and a travel destination field. In this case, the provision-information selecting unit 108 can obtain information of the travel purpose and the travel destination from the travel plan file.

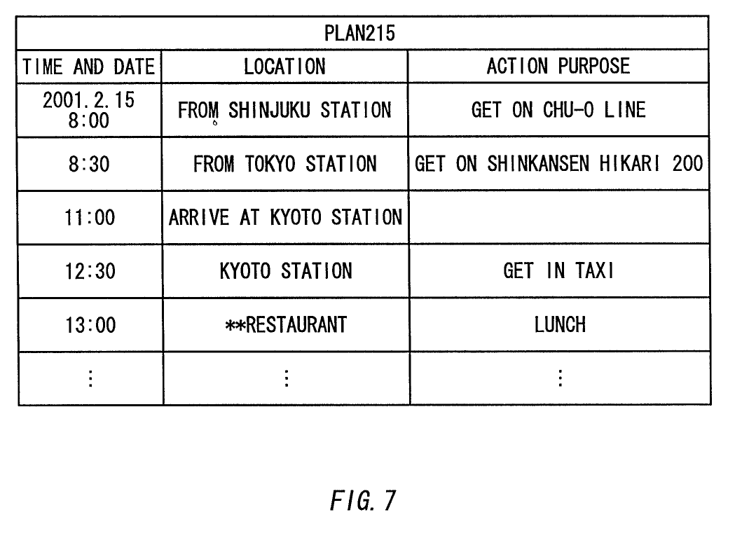

FIG. 7 shows an example of a data configuration of the travel plan file. The travel plan file includes information of the scheduled time and date, location, and the action purpose. For example, in FIG. 7, the travel plan file 215 includes information that indicates “shinjuku” as a location and “getting on the chu-o line” as an action purpose with the corresponding time and date schedule 8:00, Feb. 15th, 2000. Furthermore, the travel plan includes information that indicates “** restaurant” as a location, and “lunch” as an action purpose for the time and date for 13:00.

In this way, the travel plan file includes the location and the action purpose corresponding to the time and date schedule. Therefore, the provision-information selecting unit 108 can select the provision-information to be provided to the user based on the time and date schedule, the location, and the action purpose by referring to the travel plan file.

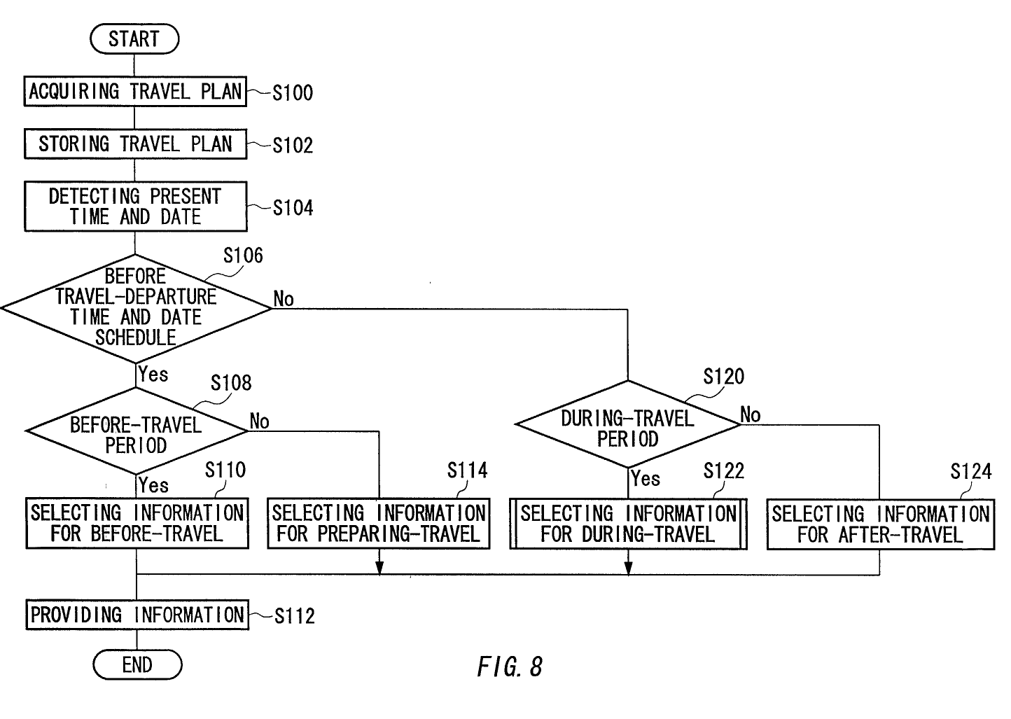

FIG. 8 is a flow chart that shows an operation of the information providing apparatus 100 of the present embodiment. The acquiring unit 102 of the information providing apparatus 100 acquires the user's travel plan from outside of the information providing apparatus 100 (S100). Then, the acquiring unit 102 stores the received travel plans into the user history database 124 so that each travel plan corresponds to the user identification information (S102). Next, the time and date detecting unit 114 detects the present time and date (S104)

Next, the comparing unit 106 compares the present time and date received from the time and date detecting unit 114 and the time and date schedule stored in the user history database 124 to recognize that the present time and date corresponds to which period of the before-travel period, the preparing-travel period, the during-travel period, and the after-travel period (S106). The information of the before-travel period, the preparing-travel period, the during-travel period, and the after-travel period are stored in the user history database 124.

If the present time and date is before the travel-departure time and date schedule (S106, Yes), and if the present time is one month or more before the travel-departure time and date schedule (S108, Yes), that is, when the present time and date corresponds to the before-travel period, the provision-information selecting unit 108 selects before-travel general information and before-travel local information.

As described in FIG. 3, the before-travel general information and before-travel local information are stored in the provision-information database 120 corresponding to the before-travel period (S110). At this time, the provision-information selecting unit 108 further selects the information to be provided to the user by selecting the information from the selected information based on the location of the travel destination. Next, the providing unit 110 sends the provision-information selected by the provision-information selecting unit 108 to the portable terminal 20 of the user (S112).

If the present time and date is before the travel-departure time and date schedule (S106, Yes), and if the present time and date is within one month before the travel-departure time and date schedule (S108, No), that is, when the present time corresponds to the preparing-travel period, the provision-information selecting unit 108 selects the preparing-travel local information and the preparing-travel traffic information (S114).

As described in FIG. 3, the preparing-travel local information and the preparing-travel traffic information are stored in the provision-information database 120 corresponding to the preparing-travel period. At this time, the provision-information selecting unit 108 further selects the information to be provided to the user by selecting the information from the selected information based on the location of the travel destination. Then, the process proceeds to step S112.

If the present time and date is after the travel-departure time and date schedule (S106, No), and if the present time and date is between the travel-departure time and date schedule and travel-finishing time and date schedule (S120, Yes), that is, when the present time corresponds to the during-travel period, the provision-information selecting unit 108 selects the during-travel local information and the during-travel moving plan (S122).

As described in FIG. 3, the during-travel local information and the during-travel moving plan are stored in the provision-information database 120 corresponding to the during-travel period. At this time, the provision-information selecting unit 108 further selects the information to be provided to the user by selecting the information from the selected information based on the location of the travel destination. Then, the process proceeds to the step S112.

If the present time and date is after the travel-departure time and date schedule (S106, No), and if the present time and date is after the travel-finishing time and date schedule (S120, No), that is, when the present time and date corresponds to the after-travel period, the provision-information selecting unit 108 selects the after-travel general information and after-travel local information stored in the provision-information database 120 (S124).

As described in FIG. 3, the after-travel general information and the after-travel local information are stored in the provision-information database 120 corresponding to the after-travel period (S110). At this time, the provision-information selecting unit 108 further selects the information to be provided to the user by selecting the information from the selected information based on the location of the travel destination. Then, the process proceeds to step S112. Then, the entire operation of the information providing apparatus 100 ends.

The provision-information selecting unit 108 may further select the information to be provided to the user from the selected information based on the purpose, the travel destination, the time and date schedule, and the user's personal information at the before-travel information selecting step (silo), the preparing-travel information selecting step (S114), the during-travel information selecting step (S122), and the after-travel information selecting step (S124).

The provision-information selecting unit 108 may use the user information stored in the user database 122. Furthermore, the provision-information selecting unit 108 may further select the information from the selected information based on how many times the user has traveled to the travel destination indicated in the travel plan. In this case, the provision-information is stored in the provision-information database 120 corresponding to the travel destination, the time and date schedule, the user information, and the number of times visiting the travel destination of the user.

The provision-information selecting unit 108 selects the provision-information using the travel destination, the time and date schedule, the user information, and how many times the user has traveled to the travel destination as a retrieval key.

In this way, because the provision-information selecting unit 108 can select the information to be provided to the user based on the user information, the provision-information selecting unit 108 can select the information that satisfies the user's individual tastes. Moreover, the timing of detecting the present time and date by the time and date detecting unit 114 may be a predetermined interval such as every 30 minutes, or every hour. The present time and date may be detected more frequently during the during-travel period than other periods.

In this way, the provision-information selecting unit 108 can select the information to be provided to the user based on the present time and date detected by the time and date detecting unit 114. Therefore, the information providing apparatus 100 can provide to the user the provision-information necessary for the user at the time when the user needs the provision-information. Therefore, for example, the user can obtain the information relating to the weather at the travel destination and the transportation used for getting to the travel destination during the preparing-travel period. Also, the user can obtain the information relating to the event held at the location closest to the user's present location.

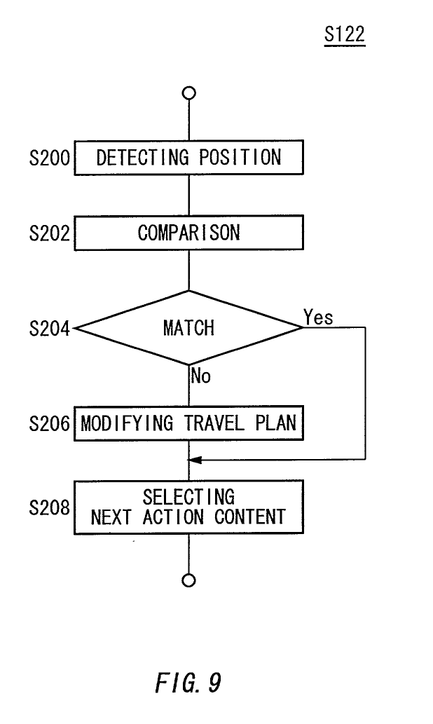

FIG. 9 is a flow chart that shows a detailed operation of the information providing apparatus 100 at the during-travel information selecting step (S122) shown in FIG. 8. If the present time and date corresponds to the during-travel period, the position-detecting unit 112 detects the position of the portable terminal 20 carried with the user (200). Next, the comparing unit 106 compares the travel destination corresponding to the time and date schedule, which corresponds to the present time and date, stored in the user history database 124 and the position of the portable terminal 20 detected by the position detecting unit 112 (S202).

If the position of the portable terminal 20 and the travel destination do not match as a result of the comparison (S204, No), the travel plan modifying unit 104 modifies the travel plan stored in the user history database 124 (S206). Next, the provision-information selecting unit 108 selects the information corresponding to the during-travel period stored in the provision-information database 120. The provision-information selecting unit 108 further selects the information corresponding to the position of the portable terminal 20 from the selected information.

The provision-information selecting unit 108 sends the selected provision-information to the providing unit 110 as information to be provided to the user (S208). At this time, the provision-information selecting unit 108 further selects the information related to the next action content contained within the travel plan, which is stored in the user history database 124 with a corresponding user. The provision-information selecting unit 108 sends the selected information relating to the next action content to the providing unit 110.

In this way, the information providing apparatus 100 can select the information corresponding to the present position of the user and the present time and date from the provision-information, which corresponds to the during-travel period, stored in the provision-information database 120 while the user travels. Then the information providing apparatus 100 can provide the selected provision-information to the user while the user travels.

For example, if the position-detecting unit 112 detects that the user is at Tokyo station, the information providing apparatus 100 can provide information relating to the place where the user can get on the Shinkansen inside Tokyo station. Therefore, the user can automatically obtain the information, which is valuable to the user.

The travel-plan modifying step (S206) in a case of providing the information to the user will be specifically explained based on the travel plan explained in FIG. 7 as an example. If the position detecting unit 112 detects that the portable terminal 20 is positioned at Shinjuku (S200), and if the time and date detecting unit 114 detects that the present time is 8:30, the comparing unit 106 will retrieve the item that corresponds to the time 8:30 in the travel plan (S202).

In the travel plan, because 8:30 is scheduled as a time to get on the Shinkansen at Tokyo station, the comparing unit 106 judges that the result of the comparison does not match (S204, No). Therefore, the travel plan-modifying unit 104 modifies the schedule indicated on the travel plan in this case (S206). For example, because the user is 30 minutes behind schedule at Shinjuku station, the travel plan-modifying unit 104 may delay the schedule after Shinjuku station for 30 minutes.

In this case, the travel plan modifying unit 104 may retrieve information regarding the Shinkansen that starts about 9:00 from Tokyo station from the provision-information database 120 and adds the retrieved results to the travel plan. Instead of retrieving the information from the portable terminal 20, the travel plan modifying unit 104 may acquire the information regarding the Shinkansen that starts about 9:00 from Tokyo station from outside the information providing apparatus 100 via the acquiring unit 102 and the Internet 10

In this way, the travel plan modifying unit 104 can suitably modify the travel plan according to the position of the portable terminal 20 detected by the position detecting unit 112 and the present time and date detected by the time and date detecting unit 114. Therefore, the information providing apparatus 100 can provide suitable information for the user according to the actual action of the user even when the user does not act according to the travel plan.

As another example, the comparing unit 106 specifies the travel destination, which corresponds to the position of the portable terminal 20 detected by the position detecting unit 112, in the user history database 124. Then, the comparing unit 106 further compares the time and date schedule, which corresponds to the specified travel destination in the user history database 124, and the present time and date. In this case, the time and date schedule is stored in the user history database 124 so that the time and date schedule corresponds to the scheduled travel destination. Also in this case, the comparing unit 106 can compare the present time and date with the time and date schedule corresponding to the travel destination of the travel plan, which is close to the present position of the portable terminal 20 detected by the position detecting unit 112.

The above case of comparing the actual schedule with the travel plan will be explained using the travel plan explained in FIG. 7. If the position detecting unit 112 detects that the portable terminal 20 is positioned at Shinjuku, and if the time and date detecting unit 114 detects 8:30 as the present time, the comparing unit 106 retrieves the item that corresponds to Shinjuku in the travel plan. Because 8:00 is retrieved corresponding with Shinjuku, the comparing unit 106 judges that the time and date schedule and the present time and date do not match. Therefore, the comparing unit 106 can detect the difference between the actual action of the user and the travel plan.

As another example, the provision-information selecting unit 108 may select the information to be provided for the user based on the degree of agreement obtained by the comparison performed by the comparing unit 106. For example, if the degree of the agreement is low, that is, if the user's action is greatly delayed from the travel plan, the providing unit 110 may notify the user that the user's action is behind the travel plan. Also, the providing unit 110 may notify the user that the providing unit 110 requests the user to modify the travel plan. The travel plan modifying unit 104 may receive a request to modifying the travel plan from the user and may modify the travel plan according to the user's request.

As another example, if the degree of agreement is low, the providing unit 110 may notify the travel agent server 30, which receives the travel plan of the user, that the user's action is behind the travel schedule. Responding with this notification, the information providing apparatus 100 may receive information that indicates modification of the contents of the travel plan from the travel agent server 30 via the acquiring unit 102. In this case, the travel plan-modifying unit 104 modifies the travel plan stored in the user history database 124 based on the contents received from the travel agent server 30.

Thereby, the travel plan modifying unit 104 can suitably modify the travel plan at the time of detecting the difference from the travel plan even when the actual schedule is greatly delayed from the travel plan. Furthermore, in this case, because the provision-information selecting unit 108 notifies the user that the travel plan is modified, the user can recognize that the travel plan is modified so that the user can act based on the modified travel plan. Therefore, if the user cannot get on the Shinkansen scheduled in the travel plan, the information providing apparatus 100 can provide information to the user of the Shinkansen available for the user as provision-information by searching for an available Shinkansen for the user based on the present time.

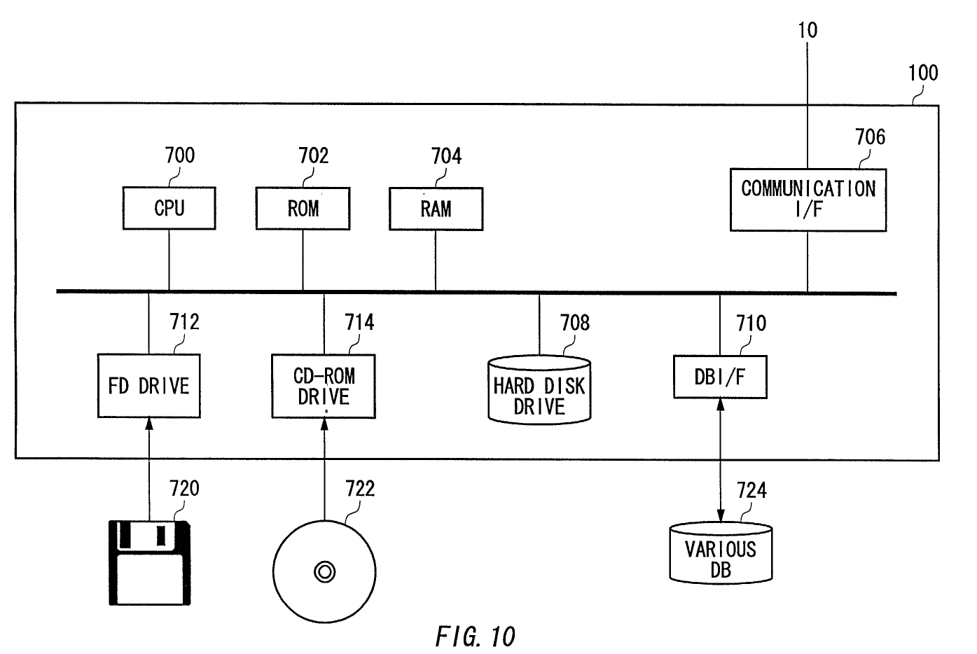

FIG. 10 shows a hardware configuration of the information providing apparatus 100. The information providing apparatus 100 has a CPU 700, a ROM 702, a RAM 704, a communication interface 706, a hard disk drive 708, a database interface 710, a Floppy disk drive 712, and a CD-ROM drive 714.

The CPU 700 operates based on the program stored in the ROM 702 and the RAM 704. The communication interface 706 communicates outside of the information providing apparatus 100 through the Internet 10. The database interface 710 writes data into the database and updates the contents of the database. The hard disk drive 708, as an example of the storing apparatus, stores the program by which the setting information and the CPU 700 are operated. The Floppy disk drive 712 reads out the data or the program from the floppy disk 720 and provides the data or the program to the CPU 700. The CD-ROM drive 714 reads out the data or program from the CD-ROM 722 and provides the data or the program to the CPU 700. The communication interface 706 receives or sends the data by connecting to the Internet 10. The database interface 710 is connected to the various databases 724 to receive and send data.

The software executed by the CPU 700 is stored in the storing medium such as the floppy disk 720 or the CD-ROM 722 and provided to the user. The software stored in the storing medium may be compressed or uncompressed. The software is read out from the storing medium, installed into the hard disk drive 708, read into the RAM 704, and then executed by the CPU 700. The software which is provided to the user by being stored in the storing medium, for example the software installed in the hard disk drive 708, has an acquiring module, a travel plan modifying module, a comparing module, a provision-information selecting module, a providing module, a position detecting module, and a time and date detecting module.

The function and the operation of each module, which works on the computer and is executed by the CPU 700, is the same as the function and operation of the corresponding member of the information providing apparatus 100 of the present embodiment. Therefore, the explanation of the function and the operation of each corresponding member will be omitted.

A part of the operation or whole of the function of the information providing apparatus 100 of the present embodiment explained in the present application can be stored in the floppy disk 720 or the CD-ROM 722 shown in FIG. 10, which is an example of the storing medium.

The program may be read from the storing medium and stored for execution in the RAM 704. The program may also be installed in the hard disk drive 708 and read into the RAM 704 to be executed. Furthermore, the program maybe stored in the signal storing medium or a plurality of storing mediums. Furthermore, the program may be stored in the storing medium in the encoded form.

As a recording medium, an optical recording medium such as DVD, a magnetic recording medium such as MD, a photo magnetic recording medium such as PD, a tape medium, a semiconductor memory such as IC card or miniature card may be used. Furthermore, a storing apparatus such as a hard disk and a RAM provided in the server system, which is connected to the leased communication network or the Internet, may be used as a recording medium, and the program may be provided to the information providing apparatus 100 through the communications network.

The recording medium as explained above is used for manufacturing the information providing apparatus 100. Therefore, it is apparent that manufacturing and selling of the recording medium as a vocation constitutes infringement of the patent based on the present application.

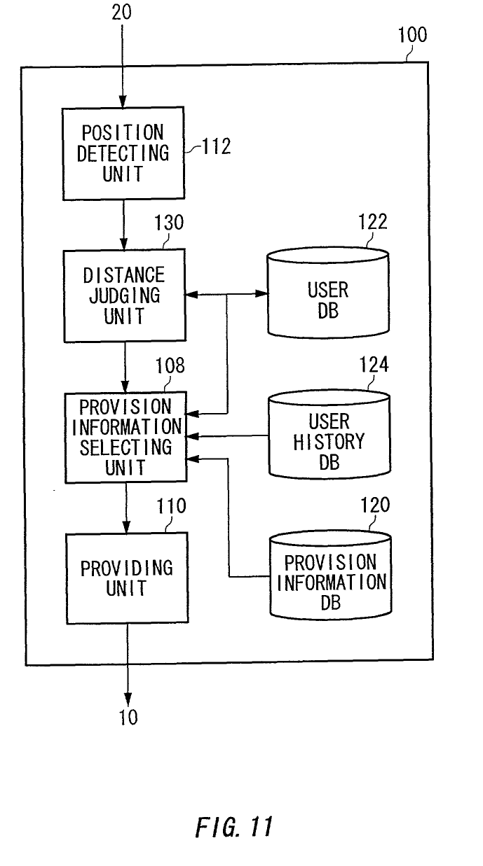

FIG. 11 is a block diagram that shows a configuration of the information providing apparatus 100 of the second embodiment. In the present embodiment, the information providing apparatus 100 has a position detecting unit 112, a distance judging unit 130, a provision-information selecting unit 108, a providing unit 110, a provision-information database 120, a user database 122, and a user history database 124. The distance judging unit 130 judges a distance from a position detected by the position detecting unit 112 to an address of the user stored in the user database 122.

In the present embodiment, the user database 122 stores the address of the user so that the user's address corresponds with the telephone number of the portable terminal 20, which is stored as user identification information. The user database 122 thereby realizes a portable terminal area table. The operation of each unit of the information providing apparatus 100 of the present embodiment other than the provision-information selecting unit 108, the distance judging unit 130, and the provision-information database 120 is the same as those of the information providing apparatus 100 of the first embodiment shown in FIG. 2. Therefore, the explanation of the operation of each unit other than the provision-information selecting unit 108, the distance judging unit 130, and the provision-information database 120 will be omitted.

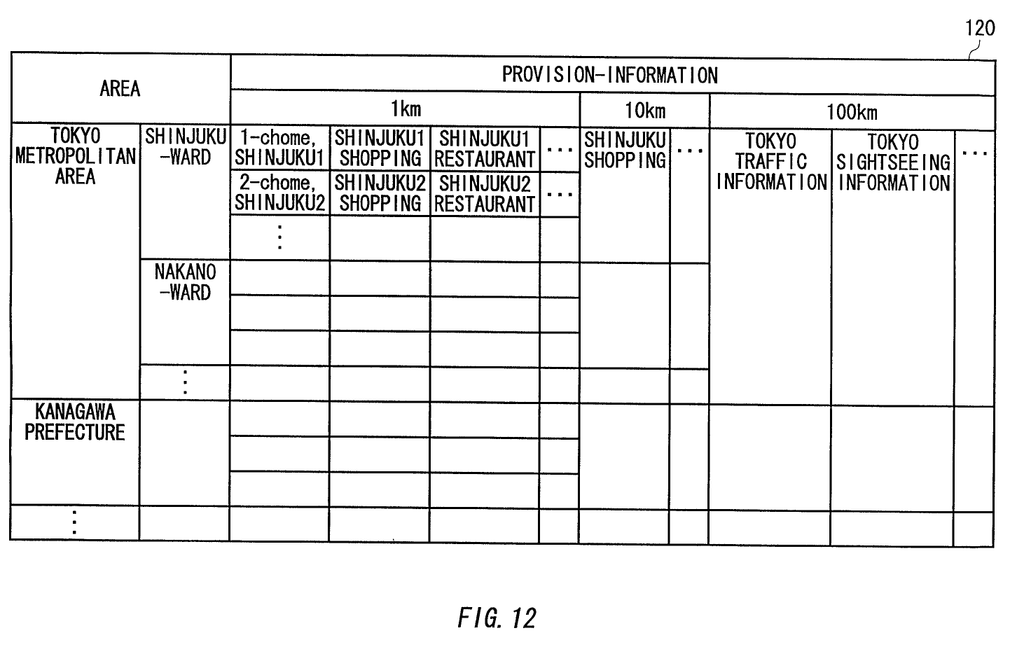

FIG. 12 shows a data configuration of the provision-information database 120. The provision-information database 120 has an area field and a provision-information field. The area field stores information that indicates the position of the user's portable terminal 20. The area field includes a field that stores the information, which indicates the prefecture such as Tokyo metropolitan or Kanagawa prefecture, a field that stores the information which indicates the city or ward such as Shinjuku ward or Nakano ward, and a field that stores the information, which indicates the town or street such as 1-chome Shinjuku or 2-chome Shinjuku.

The provision-information field includes a 100 km field, 10 km field, and 1 km field. Each field stores the provision-information to be provided to the user who moves the moving distance indicated in each field. In this way, the provision-information database 120 stores each provision-information corresponding to the user's moving distance and the area of the user's travel destination. Therefore, the provision-information-selecting unit 108 can select the information to be provided to the user based on the user's travel destination and the moving distance of the user using the provision-information database 120.

The provision-information field stores each provision-information to be provided to the user corresponding to each moving distance. The provision-information includes examples such as traffic information, sightseeing information, and shopping information, and so on. For example, the provision-information corresponding to the Tokyo metropolitan area stores information regarding traffic information related to the traffic of the whole area of the Tokyo metropolitan area and the sightseeing information that indicates the places for sightseeing in the Tokyo metropolitan area. Furthermore, the provision-information field corresponding to the Shinjuku ward stores shopping information relating to department stores in the Shinjuku ward or restaurant information relating to a restaurants in the Shinjuku ward. Furthermore, the provision-information field corresponding to 1-chome, Shinjuku stores the shopping information and restaurant information relating to a shop in 1-chome, Shinjuku.

In this way, because the provision-information database 120 stores the provision-information corresponding to each moving distance, the information providing apparatus 100 can differentiate the degree of minuteness of the provision-information to be provided to the user according to the moving distance of the user. Therefore, the information providing apparatus 100 can provide the different kinds of provision-information according to the moving distance.

In this way, the provision-information database 120 stores provision-information corresponding to the travel destination and moving distance of the user. Thus, the provision-information selecting unit 108 can provide different information to each of the users. For example, the provision-information selecting unit 108 selects different information for the user who goes to Shinjuku ward, which is inside the Tokyo metropolitan area, from another ward of the Tokyo metropolitan area with a user who travels to Shinjuku ward from Osaka city, which is located more than 100 km from the Tokyo metropolitan area.

For example, it is expected that the user,who goes to Shinjuku from Osaka city, is not familiar with the Tokyo metropolitan area. Therefore, when the information providing apparatus 100 provides information to the user who goes to Tokyo from Osaka city, the information providing apparatus 100 provides the provision-information corresponding to the moving distance 100 km or more in the provision-information database 120 based on the distance from Osaka city to Shinjuku. Therefore, the information providing apparatus 100 can provide information such as traffic information or sightseeing spot information in Tokyo.

Furthermore, the user, who goes to Shinjuku from an area within the Tokyo metropolitan area, rarely goes to a sightseeing spot in Tokyo and the user usually will travel to Shinjuku for shopping. When the information providing apparatus 100 provides information to the user who lives inside the Tokyo metropolitan area, the information providing apparatus 100 provides to the user the provision-information corresponding to the moving distance 10 km in the provision-information database 120 based on the moving distance 10 km. Therefore, the information providing apparatus 100 can provide information relating to a sightseeing spot for a user who comes to Shinjuku from Osaka city and can providee information regarding a bargain sale of the day to a user who comes to Shinjuku from an address inside the Tokyo metropolitan area.

The provision-information database 120 of the present embodiment stores the provision-information corresponding to each moving distance. As an alternative embodiment, a flag, which indicates the moving distance such as 100 km, 10 km, and 1 km, may be provided to each provision-information. Thereby, there is no need for storing the same plurality of provision-information repeatedly when the same provision-information corresponds to different moving distances. Thus, the memory can be used efficiently.

Furthermore, as another example, when the position-detecting unit 112 acquires the position information, which indicates latitude and longitude of the position of the user, from a Global Positioning System (GPS), the provision-information database 120 may store the latitude and longitude in the area field. In this case, the provision-information may be stored in the provision-information database 120 corresponding to the area classified based on latitude and longitude, for example. Because the provision-information database 120 stores the provision-information with a corresponding travel destination and moving distance, the provision-information selecting unit 108 can select the provision-information according to the travel destination and the moving distance.

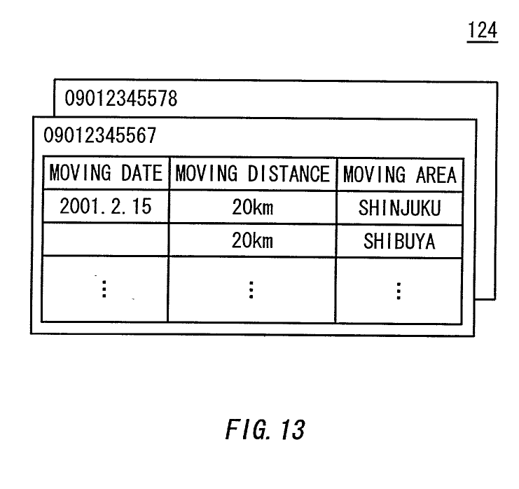

FIG. 13 shows a configuration of the data configuration of the user history database 124. The user history database 124 has tables for each user identified by the user ID. The table for each user has a moving date field, a moving distance field, and a moving area field. The moving date field stores the moving date of the user. The moving distance field stores the moving distance of the user from the user's address. The moving area field stores the area information that indicates the travel destination of the user. The user history database 124 stores the user history every time the user moves. Therefore, the provision-information selecting unit 108 can select the provision-information to be provided to the user based on the travel history of the user.

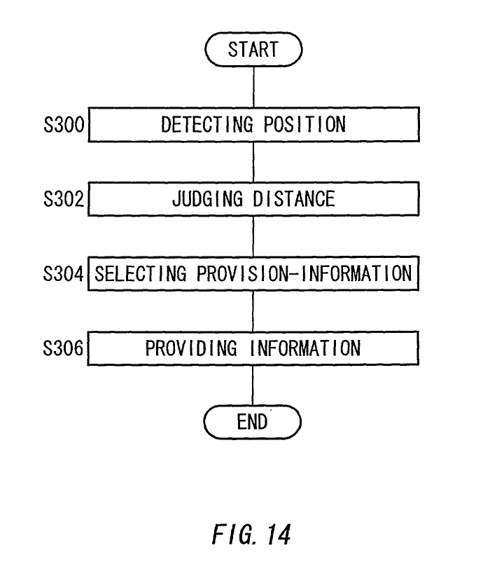

FIG. 14 shows a flow chart for describing the operation of the information providing apparatus 100 of the second embodiment. First, the position-detecting unit 112 of the information providing apparatus 100 detects the position of the portable terminal 20 carried with the user (S300). Next, the distance judging unit 130 judges the distance from the position of the portable terminal 20 detected by the position detecting unit 112 to the address of the user stored in the user database 122 (S302).

Next, the provision-information selecting unit 108 selects the provision-information to be provided to the user from the provision-information database 120 based on the position of the portable terminal 20 and the moving distance of the user (S304). At this time, the provision-information selecting unit 108 further selects the provision-information using the user's history stored in the user history database 124.

For example, if the user has already traveled to the same place in the past, the provision-information selecting unit 108 may select the provision-information about another place where the user has never visited based on the user's history at that time. Next, the providing unit 110 sends the provision-information selected by the provision-information selecting unit 108 to the portable terminal 20 of the user (S306) Then, the operation of the information providing apparatus 100 ends. Therefore, the information providing apparatus 100 of the present embodiment can provide the provision-information according to the user's travel destination and the user's moving distance.

According to the present invention, the information that the user desires can be estimated. Thus, the present embodiment can provide suitable information to a user at an appropriate time.

The modified embodiments of the first embodiment shown in FIG. 2 or the second embodiment shown in FIG. 11 will be explained below.

As a first modified embodiment, the information providing apparatus 100 may provide information to the fixed terminal owned by the user instead of providing information to the portable terminal 20 carried by the user.

As a second modified embodiment, the information providing apparatus 100 may receive a travel plan from the portable terminal 20 through the Internet 10 instead of receiving the user's travel plan from the travel agent server 30 as explained in the first embodiment shown in FIG. 2. As another embodiment, the information providing apparatus 100 may have a user interface to receive an input from the user, and the information providing apparatus 100 receives the travel plan by the user's input of his/her travel plan. Therefore, the method of acquiring the travel plan is not limited.

As a third modified embodiment, the information providing apparatus 100 may receive an action plan that indicates information such as going to a concert instead of receiving a travel plan as the first embodiment shown in FIG. 2. In this case, the information providing apparatus 100 provides information based on the action plan. The information providing apparatus 100 may provide to the user general information related to the performer in the concert during the period several months before the concert until the date of the concert.

The information providing apparatus 100 may further provide the user with information about the means of transportation to go to the concert hall and area information around the concert hall. Furthermore, the information providing apparatus 100 may provide the user with area information and transportation information based on the position of the portable terminal 20 at the date of the concert.

As another embodiment, the information providing apparatus 100 may receive information relating to the plan, of which the user is now considering, such as a Christmas party, a wedding party, or a birthday party of a child. The information providing apparatus 100 may provide general information relating to a Christmas party during the before-Christmas period, which is several months before Christmas until Christmas Day.

The information providing apparatus 100 provides to the user information relating to the Christmas event. If the user determines the plan of the Christmas event during this before-Christmas period, the user sends the determined contents to the information providing apparatus 100. Thereby, the information providing apparatus 100 provides the information according to the planned contents after receiving the planned contents. In this way, the information providing apparatus 100 can provide the information, which is suitable for the user, even when the information providing apparatus 100 does not acquire the specific plan.

As a fourth modified embodiment, the provision-information database 120 may be provided outside the information providing apparatus 100 instead of being provided inside the information providing apparatus 100 as in the first embodiment shown in FIG. 2. In this case, the information providing apparatus 100 acquires the provision-information from the provision-information database 120 that is provided outside the information providing apparatus 100. That is, the provision-information is stored in a place other than inside the information providing apparatus 100, and the provision-information database 120 may store the address of the apparatus, to which the provision-information is stored, instead of storing the provision-information itself.

Thereby, the information, on which the number of modification times is few, such as the information about each sightseeing spot, may be stored in the information providing apparatus 100. The real-time information, which is frequently modified, such as an operation condition for each time transportation is used, may be acquired from another server that manages the real-time information through the Internet 10. Therefore, the information providing apparatus 100 can provide the provision-information to the user more efficiently and further provide highly valuable information to the user.

As a fifth modified embodiment, the information providing apparatus 100 may provide information to the user when the user moves outside the terminal designating area or predetermined area, which is previously designated or predetermined to the portable terminal 20. The information providing apparatus 100 may provide information to the user when the moving distance of the user surpasses the predetermined distance instead of providing the information according to the travel destination and moving distance of the user as described in the second embodiment as shown in FIG. 11.

The provision-information selecting unit 108 may select first provision-information corresponding to the position of the portable terminal 20 detected by the position detecting unit 112 when the position detecting unit 112 detects that the portable terminal 20 position is inside a predetermined area designated to the portable terminal 20, and the provision-information selecting unit 108 may select a second provision-information corresponding to the position of the portable terminal 20 detected by the position detecting unit 112 when the position detecting unit 112 detects that the portable terminal 20 position is outside a predetermined area designated to the portable terminal 20.

Thereby, the user can acquire information about an area where the user usually does not visit only when the user moves to an area where the user usually does not visit. The terminal designating area is an area where the user moves while the user leads their daily life. For example, the terminal designating area may be designated to the area within 10 km from the user's address. In this case, the provision-information database 120 does not have to store the provision-information that corresponds to the terminal designating area of 1 km.

As a sixth modified embodiment, the position detecting unit 112 may further have an area designating unit that designates the area, which is frequently detected by the position detecting unit 112 as a position of the portable terminal 20 carried with the user, as a terminal designated area where the user leads their usual life. The above embodiment is a modified embodiment of the second embodiment of the information providing apparatus 100 as shown in FIG. 11, in which the moving distance of the user is judged using the address of the user that is previously stored in the user database 122. Thereby, the information providing apparatus 100 can select the provision-information to be provided to the user according to the user's moving distance even when the user's address is not registered in the user database 122.

As a seventh modified embodiment, the information providing apparatus 100 of the first embodiment shown in FIG. 2 may further have a distance judging unit 130 described in the second embodiment shown in FIG. 11. In this case, the provision-information database 120 may further have a data configuration of the provision-information database 120 explained in the second embodiment in the provision-information field corresponding to the during-travel period in addition to the data configuration of the provision-information database 120 explained in the first embodiment.

Thereby, the information providing apparatus 100 can provide the provision-information according to the moving distance of the user during the during-travel period. Furthermore, the information providing apparatus 100 can differentiate the degree of minuteness of the provision-information to be provided to the user according to the travel destination and the moving distance of the user. Therefore, the information providing apparatus 100 can select the types of the provision-information to be provided to the user according to the travel destination and moving distance of the user.

Furthermore, the present embodiment may further have an area designating unit explained in the second embodiment as shown in FIG. 11. In this case also, the information providing apparatus 100 can recognize the moving distance of the user based on the area designated by the area-designating unit.

Although the present invention has been described by way of exemplary embodiments, it should be understood that those skilled in the art might make many modifications and substitutions without departing from the spirit and the scope of the present invention, which is defined only by the appended claims.

What is claimed is:

1. An information providing apparatus for providing information to the user based on an action plan, comprising:
an acquiring unit for acquiring said action plan, which includes a time and date schedule of the user;
a time and date detecting unit for detecting the present time and date;
a provision-information selecting unit connected to said acquiring unit and said time and date detecting unit, said provision-information selecting unit selecting provision-information provided to the user according to the time difference between said present time and date, which is detected by said time and date detecting unit, and said time and date schedule of said action plan acquired from said acquiring unit; and
a providing unit connected to said provision-information selecting unit, said providing unit providing the user with said provision-information selected by said provision-information selecting unit.

2. An apparatus as claimed in claim 1, wherein said action plan is a travel plan that includes information of a travel destination of the user as an action content of the user.

3. An apparatus as claimed in claim 2, further comprising:
a position detecting unit for detecting a position of a portable terminal carried with the user; and
said provision-information selecting unit selects said provision-information according to said position of said portable terminal detected by said position detecting unit.

4. An apparatus as claimed in claim 1, further comprising:
a provision-information database which stores said provision-information with corresponding said time difference, wherein:
said provision-information selecting unit selects provision-information using said provision-information database.

5. An apparatus as claimed in claim 2, wherein said provision-information selecting unit selects information, which is related to preparation for travel indicated in said travel plan, as said provision-information when said present time and date is within a first period, which is a period from a predetermined time and date before said time and date schedule to said time and date schedule.

6. An apparatus as claimed in claim 2, wherein:
said action plan includes said time and date schedule of travel with corresponding said travel destination at said time and date schedule; and
said provision-information selecting unit selects information, which is related to said travel destination corresponding to said time and date schedule indicated in said action plan, as said provision-information when said present time and date is within a second period, which is a period from said time and date schedule to a predetermined time and date after said time and date schedule.

7. An apparatus as claimed in claim 5, further comprising:
a position detecting unit for detecting a position of a portable terminal carried with the user when said time and date detecting unit detects said present time and date;
a comparing unit connected to said acquiring unit, said time and date detecting unit, and said position detecting unit, said comparing unit comparing said travel destination at said time and date schedule corresponding to said present time and date with said position of said portable terminal or comparing said time and date schedule at said travel-destination corresponding to said position of said portable terminal with said present time and date; and
a travel plan modifying unit for modifying said action plan when said travel destination at said time and date schedule corresponding to said present time and date does not match said position of said portable terminal or when said time and date schedule at said travel destination corresponding to said position of said portable terminal does not match said present time and date.

8. An apparatus as claimed in claim 1, wherein said provision-information selecting unit selects said provision-information according to a purpose of an action of the user in said action plan.

9. An apparatus as claimed in claim 1, wherein said provision-information selecting unit selects said provision-information according to a past action history of the user.

10. An apparatus as claimed in claim 1, further comprising:
a user history database for storing said action plan acquired from said acquiring unit as action history information of the user with corresponding user identification information, which is used for identifying the user, wherein:
said provision-information selecting unit selects said provision-information using said action history information stored in said user history database.

11. An apparatus as claimed in claim 3, further comprising:
a user history database for storing said position of said portable terminal detected by said position detecting unit as action history information with corresponding user identification information, which is used for identifying the user who carries said portable terminal, wherein:
said provision-information selecting unit selects said provision-information using said action history information stored in said user history database.

12. An apparatus as claimed in claim 1, wherein said provision-information selecting unit differentiates a degree of minuteness of said provision-information according to a distance from an edge of a terminal designating area, which is previously determined for each of said portable terminals, to said position of said portable terminal.

13. An apparatus as claimed in claim 1, wherein said provision-information selecting unit selects a type of said provision-information according to a distance from an edge of a terminal designating area, which is previously determined for each of said portable terminals, to said position of said portable terminal.

14. An apparatus as claimed in claim 12 or 13, further comprising:
a portable terminal area table which contains portable terminal identification information for identifying said portable terminal and said terminal designating area corresponding to said portable terminal identification information, wherein:
said provision-information selecting unit recognizes said terminal designating area designated to said portable terminal using said portable terminal identification information.

15. An apparatus as claimed in claim 12 or 13, further comprising:
an area designating unit for designating said terminal designating area to said portable terminal based on a past action history of the user.

16. An apparatus as claimed in claim 2, wherein:
said provision-information selecting unit selects said provision-information according to a number of times visiting said travel destination by the user.

17. An apparatus as claimed in claim 1, wherein said provision-information selecting unit selects said provision-information according to personal information of the user.

18. An information providing apparatus for providing information to the user based on an action plan for travel of the user, comprising:
an acquiring unit for acquiring said action plan, which includes a time and date schedule for said travel and a travel destination corresponding to said time and date schedule;
a time and date detecting unit for detecting a present time and date;
a position-detecting unit for detecting a position of a portable terminal carried with the user;
a comparing unit connected to said acquiring unit, said time and date detecting unit, and said position detecting unit, said comparing unit outputting a difference-signal representing at least one of a time difference and a position difference according to the signal output from said acquiring unit, said time and date detecting unit, and said position detecting unit;
a provision-information selecting unit connected to said comparing unit, said provision-information selecting unit selecting provision-information provided to said user based on said difference-signal output from said comparing unit; and
a providing unit connected to said provision-information selecting unit for providing the user with said provision-information selected by said provision-information selecting unit.

19. An apparatus as claimed in claim 18, wherein:
said comparing unit outputs said difference-signal representing said position difference by comparing said travel destination at said time and date schedule corresponding to said present time and date with said position of said portable terminal.

20. An apparatus as claimed in claim 18, wherein:
said comparing unit outputs said difference-signal representing said time difference by comparing said time and date schedule at said travel destination corresponding to said position of said portable terminal with said present time and date.

21. An apparatus as claimed in claim 19 or 20, wherein:
said comparing unit further outputs an agreement signal representing an inverse of a degree of said time difference or said position difference obtained by said comparison; and
said provision-information selecting unit selects said provision-information according to said agreement signal output from said comparing unit.

22. An apparatus as claimed in claim 18, further comprising:
a travel plan modifying unit for modifying said action plan when said travel destination at said time and date schedule corresponding to said present time and date does not match said position of said portable terminal or when said time and date schedule at said travel destination corresponding to said position of said portable terminal does not match said present time and date, wherein:
said position-detecting unit detects a position of said portable terminal when said time and date detecting unit detects said present time and date.

23. An apparatus as claimed in claim 18, wherein said provision-information selecting unit selects said provision-information according to a purpose of said travel.

24. An apparatus as claimed in claim 18, wherein said provision-information selecting unit selects said provision-information according to action history of the user.

25. An apparatus as claimed in claim 18, further comprising:
a user history database for storing said action plan acquired from said acquiring unit as action history information of the user with corresponding user identification information, which is used for identifying the user, wherein:
said provision-information selecting unit selects said provision-information using said action history information stored in said user history database.

26. An apparatus as claimed in claim 18, further comprising:
a user history database for storing said position of said portable terminal detected by said position detecting unit as action history information with corresponding user identification information, which is used for identifying the user who carries said portable terminal, wherein:
said provision-information selecting unit selects said provision-information using said action history information stored in said user history database.

27. An apparatus as claimed in claim 18, wherein said provision-information selecting unit differentiates a degree of minuteness of said provision-information according to a distance from an edge of a terminal designating area, which is previously determined for each of said portable terminals, to said position of said portable terminal.

28. An apparatus as claimed in claim 18, wherein said provision-information selecting unit selects a type of said provision-information according to a distance from an edge of a terminal designating area, which is previously determined for each of said portable terminals, to said position of said portable terminal.

29. An apparatus as claimed in claim 27 or 28, further comprising:
a portable terminal area table which contains portable terminal identification information for identifying said portable terminal and said terminal designating area corresponding to said portable terminal identification information, wherein:
said provision-information selecting unit recognizes said terminal designating area designated to said portable terminal using said portable terminal identification information.

30. An apparatus as claimed in claim 27 or 28, further comprising:
an area designating unit for designating said terminal designating area to said portable terminal based on action history of the user.

31. An apparatus as claimed in claim 18, wherein:
said provision-information selecting unit selects said provision-information according to a number of times visiting said travel destination by the user.

32. An apparatus as claimed in claim 18, wherein said provision-information selecting unit selects said provision-information according to personal information of the user.

33. An information providing apparatus for providing information to the user, comprising:
a position-detecting unit for detecting a position of a portable terminal carried with the user;
a provision-information selecting unit connected to said position detecting unit, said provision-information selecting unit selecting first provision-information corresponding to said position of said portable terminal detected by said position detecting unit when said position detecting unit detects that said portable terminal positions inside a predetermined area designated to said portable terminal, and said provision-information selecting unit further selecting second provision-information corresponding to said position of said portable terminal detected by said position detecting unit when said position detecting unit detects that said portable terminal positions outside a predetermined area designated to said portable terminal; and
a providing unit connected to said provision-information selecting unit, said providing unit providing the user with one of said first provision-information and said second provision-information selected by said provision-information selecting unit.

34. An apparatus as claimed in claim 33, wherein said provision-information selecting unit selects one of said first provision-information and said second provision-information according to moving distance information which indicates a distance from a position of said portable terminal and an edge of said predetermined area designated to said portable terminal.

35. An apparatus as claimed in claim 34, further comprising:
a provision-information database for storing said first provision-information and said second provision-information with corresponding said moving distance information; and
said provision-information selecting unit selects one of said first provision-information and said second provision-information using said provision-information database.

36. An apparatus as claimed in claim 33, wherein said provision-information selecting unit selects one of said first provision-information and said second provision-information according to said predetermined area determined based on action history of the user.

37. An apparatus as claimed in claim 33, further comprising:
a user history database for storing said position of said portable terminal detected by said position detecting unit as action history information with corresponding user identification information, which is used for identifying the user who carries said portable terminal, wherein:
said provision-information selecting unit selects one of said first provision-information and said second provision-information using said action history information stored in said user history database.

38. An apparatus as claimed in claim 33, further comprising:
a user history database for storing said action plan acquired from said acquiring unit as action history information of the user with corresponding user identification information, which is used for identifying the user, wherein:
said provision-information selecting unit selects one of said first provision-information and said second provision-information based on said predetermined are a determined by said action history information stored in said user history database.

39. An apparatus as claimed in claim 33, wherein said provision-information selecting unit differentiates a degree of minuteness of one of said first provision-information and said second provision-information according to a distance from an edge of said predetermined area to said position of said portable terminal.

40. An apparatus as claimed in claim 33, wherein said provision-information selecting unit selects a type of one of said first provision-information and said second provision-information according to a distance from an edge of said predetermined area to said position of said portable terminal.

41. An apparatus as claimed in claim 33, further comprising:
a portable terminal area table which includes portable terminal identification information for identifying said portable terminal and said predetermined area corresponding to said portable terminal identification information, wherein:
said provision-information selecting unit recognizes said predetermined area using said portable terminal area table.

42. An apparatus as claimed in claim 33, further comprising:
an area designating unit for designating said predetermined area to said portable terminal based on action history of the user.

43. An apparatus as claimed in claim 33, wherein:
said provision-information selecting unit selects one of said first provision-information and said second provision-information according to said predetermined area determined on the number of times the user visits said predetermined area.

44. An apparatus as claimed in claim 33, wherein said provision-information selecting unit selects one of said first provision-information and said second provision-information according to said predetermined area determined on personal information of the user.

45. An information providing apparatus for providing information to the user, comprising:
a position-detecting unit for detecting a position of a portable terminal carried with the user;
a provision-information selecting unit connected to said position detecting unit, said provision-information selecting unit selecting provision-information to be provided to the user, which corresponds to said position of said portable terminal, according to a distance of said position of said portable terminal from an edge of a predetermined area designated to said portable terminal; and
a providing unit connected to said provision-information selecting unit for providing the user with said provision-information selected by said provision-information selecting unit.

46. A method for providing information to the user based on an action plan, comprising:
acquiring said action plan, which includes a time and date schedule of the user;
detecting present time and date;
selecting provision-information according to the time difference between said present time and date and said time and date schedule of said action plan; and
providing the user with said selected provision-information.

47. A method for providing information to the user based on an action plan for travel of the user, comprising:
acquiring the action plan, which includes a time and date schedule for the travel and a travel destination corresponding to said time and date schedule;
detecting a present time and date;
detecting a position of a portable terminal carried with the user;
outputting a difference-signal representing at least one of a time difference and a position difference according to said time and date schedule, said travel destination, said present time and date, and said position of said portable terminal;
selecting provision-information based on said difference-signal; and
providing the user with said selected provision-information.

48. A method for providing information to the user, comprising:
detecting a position of a portable terminal carried with the user;
selecting first provision-information corresponding to said position of said portable terminal when said position of said portable terminal is detected to be inside a predetermined area designated to said portable terminal;
selecting second provision-information corresponding to said position of said portable terminal when said position of said portable terminal is detected to be outside a predetermined area designated to said portable terminal; and
providing the user with one of said first provision-information and said second provision-information selected by said selecting.

49. A computer program for providing information to the user based on an action plan, comprising:
an acquiring module for acquiring said action plan, which includes a time and date schedule of the user;
a time and date detecting module for detecting present time and date;
a provision-information selecting module for selecting provision-information provided to the user according to the time difference between said present time and date, which is detected by said time and date detecting module, and said time and date schedule of said action plan acquired from said acquiring module; and
a providing module for providing the user with said provision-information selected by said provision-information selecting module.

50. A computer program for providing information to the user based on an action plan for travel of the user, comprising:
an acquiring module for acquiring said action plan, which includes a time and date schedule for said travel and a travel destination corresponding to said time and date schedule;
a time and date detecting module for detecting a present time and date;
a position-detecting module for detecting a position of a portable terminal carried with the user;
a comparing module for outputting a difference-signal representing at least one of a time difference and a position difference according to the signal output from said acquiring module, said time and date detecting module, and said position detecting module;
a provision-information selecting module for selecting provision-information provided to the user based on said difference-signal output from said comparing module; and
a providing module for providing the user with said provision-information selected by said provision-information selecting module.

51. A computer program for providing information to the user, comprising:
a position-detecting module for detecting a position of a portable terminal carried with the user;
a provision-information selecting module for selecting first provision-information corresponding to said position of said portable terminal detected by said position detecting module when said position detecting module detects that said portable terminal positions inside a predetermined region designated to said portable terminal, and selecting second provision-information corresponding to said position of said portable terminal detected by said position detecting module when said position detecting module detects that said portable terminal position is outside a predetermined region designated to said portable terminal; and
a providing module for providing the user with one of said first provision-information and said second provision-information selected by said provision-information selecting module.
